(19) United States
(12) Patent Application Publication
(10) Pub. No.: US 2005/0280214 A1
(43) Pub. Date: Dec. 22, 2005

(54) Elastomer coated screen gasket

(76) Inventor: Jeffrey Lane Richards, Holly, MI (US)

Correspondence Address: FREUDENBERG-NOK GENERAL PARTNERSHIP;INTELLECTUAL PROPERTY DEPARTMENT, 47690 E. ANCHOR COURT, PLYMOUTH, MI, 48170-2455, US

(21) Appl. No.: 10/873,845

(22) Filed: Jun. 22, 2004

(51) Int. Cl. F16J 15/02

(52) U.S. Cl. 277/608; 277/628

(57) ABSTRACT

A gasket is provided including a screen. An elastomeric material coats the screen. In one embodiment, the elastomeric material provides sealing ribs to provide a tight seal.

### FIELD OF THE INVENTION

The present invention relates to gaskets, and more particularly, to an elastomer coated screen gasket.

### BACKGROUND OF THE INVENTION

Gaskets have been used for many years for providing a sealed connection between two relatively static members. Gaskets typically require a compressive load between the members being sealed in order for the gasket to provide an effective seal. For example, a gasket placed between two stationary members, such as an engine block and an oil pan or an engine cylinder head and a valve/cam cover, is compressed between these elements.

One gasket design has a solid metal core which may or may not be coated or partially coated with a polymeric material. The use of a solid metal core increases the cost of the gasket and requires a greater thickness due to the stamping operation used to manufacture the metal core. Furthermore, any desired change in shape of the gasket requires new stamping plates, making minor design changes cost prohibitive. In addition, the polymeric material coating the gasket may be hard to process requiring longer manufacturing times and further increasing the cost of the gasket.

Accordingly, a need exists for a gasket having reduced cost and greater design flexibility.

### SUMMARY OF THE INVENTION

The present invention provides a gasket including a wire screen. An elastomeric material coats the wire screen. The use of a wire screen reduces the cost of the gasket while improving durability and design flexibility.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an elastomer coated screen gasket according to the principles of the present invention;

FIG. 2 is a schematic view of a wire screen used in the gasket of the present invention;

FIG. 3 is a cross sectional view taken along line 3-3 of FIG. 1; and

FIG. 4 is a magnified view of detail 3 in FIG. 3.

### DETAILED DESCRIPTION OF THE PREFERRED EMBODIMENTS

The following description of the preferred embodiments is merely exemplary in nature and is in no way intended to limit the invention, its application, or uses.

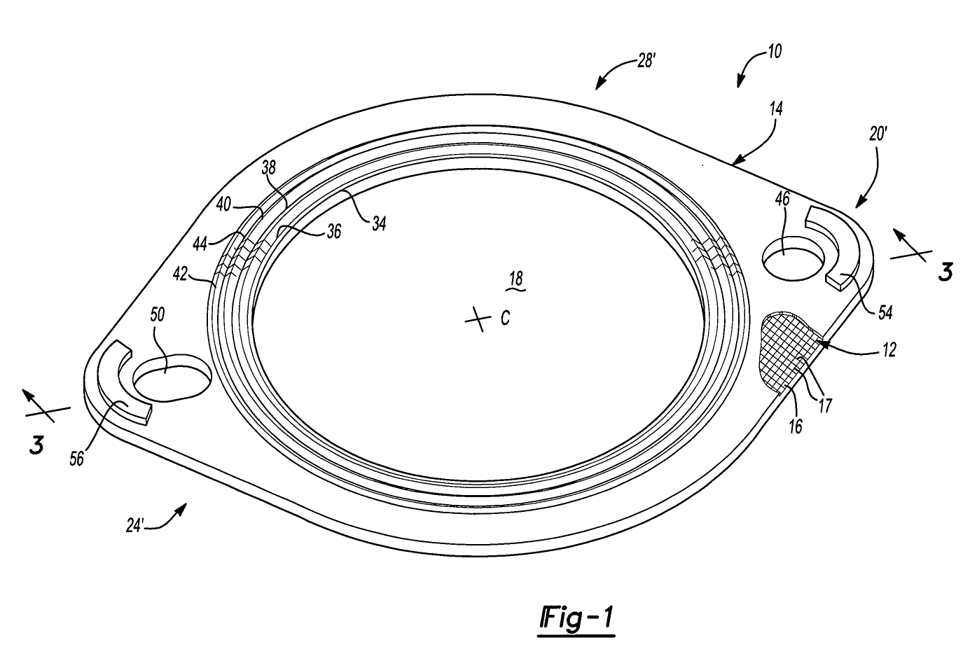

Referring now to FIG. 1, a gasket 10 according to the principles of the present invention is shown. It will be understood that the shape and dimensions of the gasket 10 enclosed herein are for illustrative purposes only and do not limit the scope of the present application. The gasket 10 includes a screen 12 embedded in an elastomeric material 14.

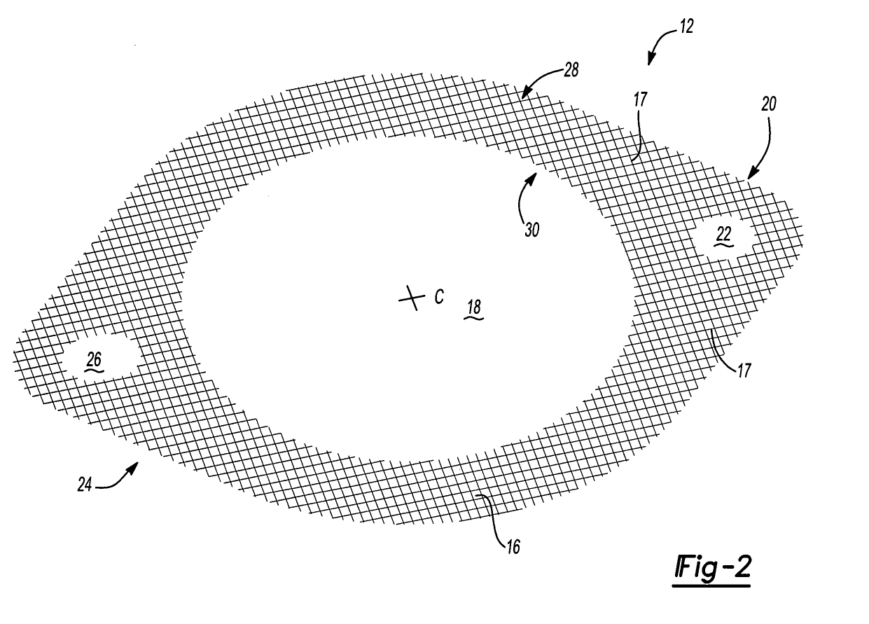

The screen 12 (as illustrated in FIG. 2) includes several openings 16 between the cross weaved wires 17 which facilitate the flow of the elastomeric material 14 therethrough while the gasket 10 is being molded. The screen 12 may be comprised of aluminum, copper, steel, carbon fiber, perforated sheeting, such as MYLAR, or any other suitable material and may be pre-cut into a desired shape prior to the introduction of the elastomeric material 14 or may be in sheet form and cut later. The screen 12 has a thickness T which according to a first embodiment may be approximately 0.2 millimeters (mm) to 0.3 millimeters (mm). The thickness T is generally uniform. A central aperture 18 may be formed along a centerline C prior to the introduction of the elastomeric material 14.

With reference now to FIG. 2, a first end 20 of the screen 12 may further include a first aperture 22 for receipt of a first coupling mechanism (not shown), such as, for example, a bolt or screw, therethrough. The screen 12 has a second end 24 which may include a second aperture 26 for receipt of a second coupling mechanism (not shown). The screen 12 has a top side 28 and a bottom side 30 which is coated with the elastomeric material 14.

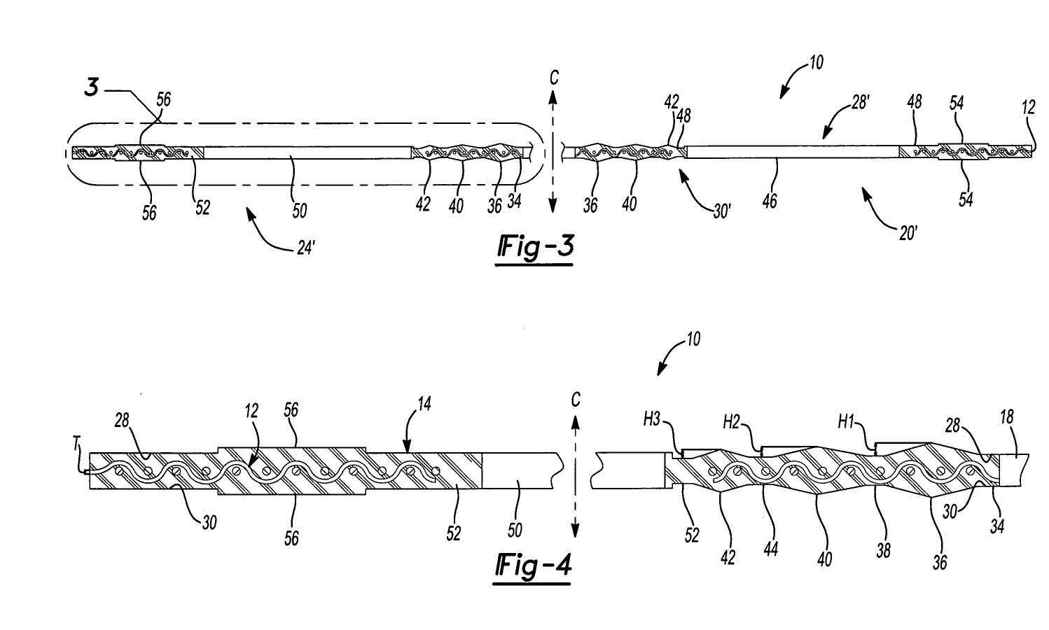

With continuing reference to FIG. 2 and additional reference to FIGS. 1, 3 and 4, the elastomeric material 14 may coat the top side 28 and bottom side 30 of the screen 12 such that the screen 12 is completely embedded by the elastomeric material 14, forming the gasket top side 28′ and the gasket bottom side 30′, each having a first end 20′ and a second end 24′. The central aperture 18 of the screen 12 may be coated or remain uncoated by the elastomeric material 14.

Both the top side 28′ and the bottom side 30′ may include a plurality of sealing ribs 36, 40, 42. The plurality of sealing ribs 36, 40, 42 may be formed from elastomeric material 14 and may surround the central aperture 18 of the screen 12. More specifically, an area 34 having a first predetermined thickness may be formed directly adjacent to the central aperture 18. The area 34 is adjacent a first sealing rib 36. The first sealing rib 36 is adjacent a valley 38. The valley 38 is further adjacent to a second sealing rib 40. The second sealing rib 40 is separated from a third sealing rib 42 by a second valley 44. The first sealing rib 36 has a height H1 which is generally greater than a height H2 of the second sealing rib 40. The third sealing rib 42 also has a height H3 which is generally smaller than the height H2 of the second sealing rib 40. The valleys 38 and 44 are configured such that when a downward force F is applied to the first, second and third sealing ribs 36, 40 and 42, the first, second and third sealing ribs 36, 40 and 42 can deform into the valleys 38 and 44. The first, second and third sealing ribs 36, 40, 42 ensure a tight seal.

The first end 20′ of gasket 10 may include a first mounting aperture 46 which corresponds to the first aperture 22 of the screen 12 for receipt of the first coupling mechanism therethrough. The first mounting aperture 46 may be configured to extend beyond the first aperture 22 of the screen 12 to provide a first elastomeric buffer region 48. Similarly, the second end 24′ of gasket 10 may include a second mounting aperture 50 corresponding to the second aperture 26 of the screen 12 for receipt of the second coupling mechanism therethrough. The second mounting aperture 50 may also extend beyond the second aperture 26 of the screen 12 to form a second elastomeric buffer region 52. The first and second elastomeric buffer regions 48, 52 ensure a tight seal against the first and second coupling mechanism. It should be understood that the screen 12 may be completely coated with the elastomeric material prior to a cutting process during which the apertures in the screen are formed.

A first raised portion or shelf 54 may be formed adjacent to the first mounting aperture 46 on both the top side 28′ and bottom side 30′ of gasket 10. A second raised portion or shelf 56 may also be formed on both the top side 28′ and bottom side 30′ adjacent to the second mounting aperture 50. The first raised portion 54 and second raised portion 56 provide a support to prevent the flexing of a part (not shown) which mates with the gasket 10 and thus further ensures a tight seal.

The elastomeric material 14 may comprise nitrile rubber (NBR) with a low acrylonitrile (ACN) content, medium ACN content NBR, high ACN content NBR, butyl-chlorobutyl, chloroprene, chlorosulfonated polyethylene, ethylene propylene, epichlorohydrin, ethylene vinyl acetate, floursilicone, fluorocarbon, hydrogenated NBR, polyisoprene, polyuacrylate, propylene oxide, polybutadiene, polysulfide, modified NBR, silicone, styrene butadiene rubber (SBR) or any enhanced performance polymer or thermoplastic elastomer.

To form the gasket 10 of the present invention, the screen 12 is placed into a mold cavity (not shown). The screen 12 may be of a pre-determined shape or may be in sheet form. Next, the elastomeric material 14 is injected into the mold cavity. The elastomeric material 14 then flows through the openings 16 in the screen 12 to substantially coat the top and bottom of the screen 12, forming the top side 28′ and the bottom side 30′ of the gasket 10. In this embodiment, the mold cavity is such that the elastomeric material 14 flows around the central aperture 18, however, it is envisioned that the central aperture 18 could be created in a later processing step. Likewise, the mold cavity may also be configured to enable the elastomeric material 14 to flow and create the first and second mounting apertures 46, 50 or the first and second mounting apertures 46, 50 may be created in a later processing step. In addition, the mold cavity may be configured to allow excess elastomeric material 14 to form the first, second and third sealing ribs 36, 40, 42. In addition, the mold cavity could be designed such that excess elastomeric material 14 may form the first raised portion 54 and the second raised portion 56 adjacent the first and second mounting apertures 46, 50.

The gasket 10 of the present invention reduces the weight and cost of current gaskets through the use of a screen 12. The screen 12 provides the gasket 10 with a compression limiting feature while enabling the gasket 10 to have a reduced thickness. The screen 12 also enables the shape of the gasket 10 to be easily modified to suit any desired design change. The use of the screen 12 also reduces the amount of torque required to create a sufficient seal. In addition, the elastomeric material 14 coating the screen 12 is generally more durable, resistant and easier to process than current elastomeric materials used in gaskets.

The description of the invention is merely exemplary in nature and, thus, variations that do not depart from the gist of the invention are intended to be within the scope of the invention. Such variations are not to be regarded as a departure from the spirit and scope of the invention.

1. A gasket comprising:
a screen; and
a elastomeric material embedding the screen

2. The gasket of claim 1 further comprising an opening disposed in the screen and the elastomeric material.

3. The gasket of claim 2 further comprising at least one molded sealing rib adjacent to the opening.

4. The gasket of claim 3 wherein the at least one molded sealing rib surrounds the opening.

5. The gasket of claim 1 wherein the gasket includes a first and a second end and at least one mounting aperture located in at least one of the first end and the second end.

6. The gasket of claim 5 further comprising at least one molded shelf portion adjacent to the at least one mounting aperture.

7. The gasket of claim 1 wherein the screen includes openings sized to enable the elastomeric material to flow through the openings.

8. The gasket of claim 1 wherein the elastomeric material is selected from the group consisting of: nitrile rubber (NBR) with a low acrylonitrile (ACN) content, medium ACN content NBR, high ACN content NBR, butyl-chlorobutyl, chloroprene, chlorosulfonated polyethylene, ethylene propylene, epichlorohydrin, ethylene vinyl acetate, floursilicone, fluorocarbon, hydrogenated NBR, polyisoprene, polyuacrylate, propylene oxide, polybutadiene, polysulfide, modified NBR, silicone, and styrene butadiene rubber (SBR).

9. The gasket of claim 1 wherein the elastomeric material is a thermoplastic elastomer.

10. The gasket of claim 1 wherein said gasket includes a first face and a second face;
a plurality of molded sealing ribs being formed in at least one of said first and second faces; and
wherein a first molded sealing rib of the plurality of sealing ribs has a greater height than at least a second one of the plurality of sealing ribs located adjacent the first molded sealing rib.

11. A gasket comprising:
a wire screen; and
an elastomeric material embedding the wire screen.

12. The gasket of claim 11 wherein the gasket further comprises an opening disposed in the wire screen and the elastomeric material.

13. The gasket of claim 12 further comprising at least one sealing rib formed from the elastomeric material and surrounding the opening.

14. The gasket of claim 11 wherein the gasket further comprises at least one mounting aperture located between said opening and an edge of said gasket.

15. The gasket of claim 14 wherein the gasket further comprises at least one molded shelf adjacent to the mounting aperture.

16. The gasket of claim 11 wherein the elastomeric material is a thermoplastic elastomer.

17. The gasket of claim 11 wherein the elastomeric material is selected from the group consisting of nitrile rubber (NBR) with a low acrylonitrile (ACN) content, medium ACN content NBR, high ACN content NBR, butyl-chlorobutyl, chloroprene, clorosulfonated polyethylene, ethylene propylene, epichlorohydrin, ethylene vinyl acetate, floursilicone, fluorocarbon, hydrogenated NBR, polyisoprene, polyuacrylate, propylene oxide, polybutadiene, polysulfide, modified NBR, silicone, and styrene butadiene rubber (SBR).

18. The gasket of claim 11 wherein the at least one crush rib further comprises:
a first sealing rib adjacent to and surrounding the opening;
a second sealing rib adjacent the first sealing rib;
a third sealing rib adjacent to the second sealing rib; and
wherein the first sealing rib is greater in height than the second sealing rib and the second sealing rib is greater in height than the third sealing rib.

19. The gasket of claim 11, wherein said wire screen includes woven wires.

20. The gasket of claim 1, wherein said screen includes strands of material.
